(19) United States
(12) Patent Application Publication
(10) Pub. No.: US 2013/0248034 A1
(43) Pub. Date: Sep. 26, 2013

(54) PRESSING WATERWAY SWITCH MECHANISM

(71) Applicants: Huasong Zhou, Xiamen (CN); Fuli Guo, Xiamen (CN); Haisong Peng, Xiamen (CN); Hui Huang, Xiamen (CN)

(72) Inventors: Huasong Zhou, Xiamen (CN); Fuli Guo, Xiamen (CN); Haisong Peng, Xiamen (CN); Hui Huang, Xiamen (CN)

(73) Assignees: XIAMEN SOLEX HIGH-TECH INDUSTRIES CO., LTD., Xiamen, Fujian (CN); Huasong ZHOU, Xiamen, Fujian (CN)

(21) Appl. No.: 13/991,493

(22) PCT Filed: Dec. 15, 2011
(86) PCT No.: PCT/CN2011/084050

§ 371 Date: Jun. 4, 2013

(30) Foreign Application Priority Data
Dec. 20, 2010 (CN) 201010596272.4

(51) Int. Cl. F16K 11/02

(52) U.S. Cl. CPC F16K 11/02
USPC 137/871

(57) ABSTRACT

A pressing waterway switch mechanism has a valve body and a switch mechanism. The valve body is provided with an inlet waterway, a plurality of outlet waterways, a guiding shaft, a guiding slot and a third teeth group. The switch mechanism comprises a sector disk, a return spring and a pressing piece. A first teeth group is arranged on the circle center of the sector disk, the first teeth group is sleeved out of the guiding shaft in a relative sliding and rotating manner, and at least the switch of a plurality of outlet waterways can be achieved through the relative rotation between the sector disk and the valve body. The pressing piece is connected to the guiding slot in a sliding manner, of which the end is provided with a second teeth group. The first teeth group can couple with the second teeth group and the third teeth group.

### FIELD OF THE INVENTION

The present invention relates to a pressing waterway switch mechanism.

### BACKGROUND OF THE INVENTION

The waterway switch mechanism of the bathroom equipment mainly comprises the rotary waterway switch mechanism and the sliding waterway switch mechanism. The rotary waterway switch mechanism at the prior art achieves the switch mainly through the relative rotation between the sector disk and the valve body. a rotary face cover is arranged out of the valve body, and a synchronous and coaxial rotation connection relation is formed between the face cover and the sector disk, and a raised handle is arranged on the face cover, and then the face cover can be rotated with respect to the valve body by operating the raised handle, and then the sector disk can be driven to rotate with respect to the valve body, and then the waterway switch is achieved. The rotary waterway switch mechanism at the prior art is provided with the following defects: 1 the sector disk and the valve body are always relying on each other, providing with large switch force and inconvenient switch; 2 the face cover is connected with the valve body in a rotating manner, providing with complicated structure and large space occupation.

### SUMMARY OF THE INVENTION

The object of the present invention is to offer a pressing waterway switch mechanism which overcomes the defects of the rotary waterway switch mechanism at the prior art.

The technical proposal solving the technical matter in the present invention is:

Pressing waterway switch mechanism, comprises:

A valve body (100), provided with an inlet waterway (110), at least two outlet waterways (120), a guiding shaft (130), a guiding slot (144) of which the guiding direction coincides with the axis of the guiding shaft (130), a third teeth group (145) that is around the guiding slot (144), and inlet ports (121) of the outlet waterways (120) can be communicated with the inlet waterway (110) and be alternatively arranged around the guiding shaft (130) in a ring array manner;

A switch mechanism, comprises:

A sector disk (210), a first teeth group (211) is arranged at the circle center, and can be sleeved out of the guiding shaft (130) in a relative sliding and rotating manner, and at least the switch of a plurality of outlet waterways (120) can be achieved through the relative rotation between the sector disk (210) and the valve body (100);

A return spring (220), is sleeved to the guiding shaft (130) and against the first teeth group (211);

A pressing piece (230), can be connected to the guiding slot (144) in a sliding manner, and a second teeth group (231) is arranged at the end of the pressing piece;

Wherein, the first teeth group (211) can couple with the second teeth group (231) and the third teeth group (145), to cause that: the pressing piece (230) is pressed to move forward, and the first teeth group (211) and the second teeth group (231) are coupling with each other, and then the sector disk (210) slides forward and rotates forward, and energy is stored in the return spring (220); then energy is released from the return spring (220), and then the sector disk (210) slides backward, and the first teeth group (211) and the third teeth group (145) are coupling with each other, and then the sector disk (210) rotates forward, and then the pressing piece (230) returns.

In a preferred embodiment, the sector disk (210) can seal the inlet ports (121) in a coupling manner.

In a preferred embodiment, the number of the outlet waterways (120) is two, and the sector disk (210) can seal an inlet port (121) alternatively or the sector disk (210) can be between the two inlet ports (121).

In a preferred embodiment, the switch mechanism also comprises:

A button (240), which is connected to the valve body (100) in a sliding manner and be against the pressing piece (230), so that the pressing piece (230) can be driven to slide when the button (240) is pressed, a locating rod (241) is arranged on the button (240), and a locating slot (147) is arranged on the valve body (100), and the locating rod (241) is connected to the locating slot (147) in a coupling manner; and

A against spring (250), which is arranged between the button (240) and the valve body (100).

In a preferred embodiment, the valve body (100) comprises:

A main body (140), an outlet cavity (143) is concavely arranged on the top surface of the main body (140), of which the bottom surface is the switch surface (146), the outlet waterways (120) are arranged in the main body (140), and the inlet ports (121) are on the switch surface (146), the guiding slot (144) penetrates the main body (140), and the third teeth group (145) is on the switch surface (146);

An upper cover (150), which is mounted on the circular surface of the outlet cavity (143) of the main body (140), and the inlet waterway (110) penetrates the upper cover (150) to introduce water into the outlet cavity (110) from water source.

In a preferred embodiment, the upper cover (150) comprises a top wall (151) and a surrounding wall (152) extended from the periphery of the top wall (151) downward, and the surrounding wall (152) is fixed to the outlet cavity (143) of the main body (140) hermetically, and the inlet waterway (110) penetrates the top wall (151); the guiding shaft (130) is fixed to the bottom surface of the top wall (151) of the upper cover (150).

In a preferred embodiment, the sector disk (210) is in the outlet cavity (143) of the main body (140), the return spring (220) is against between the top wall (151) and the sector disk (210).

In a preferred embodiment, a mounting groove (141) is concavely arranged on the bottom of the main body (140), and a axial locating slot (142) is arranged on the internal revolution surface of the mounting groove (141); the button (240) is connected to the mounting groove (141) in a coupling and sliding manner, and a guiding embossment (242) is arranged out of the button (240), and the embossment (242) is connected to the locating slot (142) in a coupling manner.

In a preferred embodiment, the against spring (250) is against between the bottom surface of the mounting groove (141) and the button (240).

In a preferred embodiment, the outlet ports (122) of the outlet waterways (120) are radially ahead outward.

Compared with the technical proposal at the prior, the benefits of the present invention are:

1 the pressing piece, the return spring, the sector disk, and the valve body are cooperated to form an automatic-ball-pen-type mechanism, and the pressing piece is pressed to slide forward, and then the sector disk slides forward and rotates forward, and energy is stored in the return spring; when the pressing is loosen, energy is released from the return spring, and then the sector disk slides backward and rotates forward, it overcomes the defects at the prior art and generates the following effects: a, during the switch process, the sector disk is separated from the switch surface of the valve body with no friction, labor saving and convenient switch operation; b, the rotation of the sector disk is driven through pressing with convenient switch operation, simple structure and low space occupation; c, it is easy to design the hermetic structure; d, the sector disk is used without the area that is affected by water pressure during operation process, and then the operation force is reduced;

2 the sector disk can be chosen to seal one inlet port or the sector disk can be between the two inlet ports, not only it can achieve the switch of the two outlet waterways, but also that water can come out of the two outlet waterways simultaneously;

3 the valve body comprises a main body and a top cover with reasonable arrangement, low manufacturing cost and easy assembly;

4 the switch mechanism also comprises a button and a against spring for user's easy pressing;

5 the sector disk is in the outlet cavity of the main body, and the button is connected to the mounting groove in a sliding and coupling manner with reasonable arrangement and low space occupation.

### BRIEF DESCRIPTION OF THE DRAWINGS

With the following description of the drawings and specific embodiments, the invention shall be further described in details.

FIG. 1 shows the solid general abridged view of the mechanism in a preferred embodiment;

FIG. 2 shows the solid exploded view of the mechanism in a preferred embodiment;

FIG. 3 shows the solid assembly view of the main body, the pressing piece and the sector disk of the mechanism in a preferred embodiment;

FIG. 4 shows the half sectional view of the mechanism in a preferred embodiment;

FIG. 5 shows the solid half sectional view of the mechanism in a preferred embodiment, and water comes out of both the outlet waterways at this moment;

FIG. 6 shows the sectional view of FIG. 5 A-A, and water comes out of both the outlet waterways at this moment;

FIG. 7 shows the sectional view of FIG. 5 A-A, and water comes out of the first outlet waterways at this moment;

FIG. 8 shows the sectional view of FIG. 5 A-A, and water comes out of the second outlet waterways at this moment.

### DESCRIPTION OF THE PREFERRED EMBODIMENTS

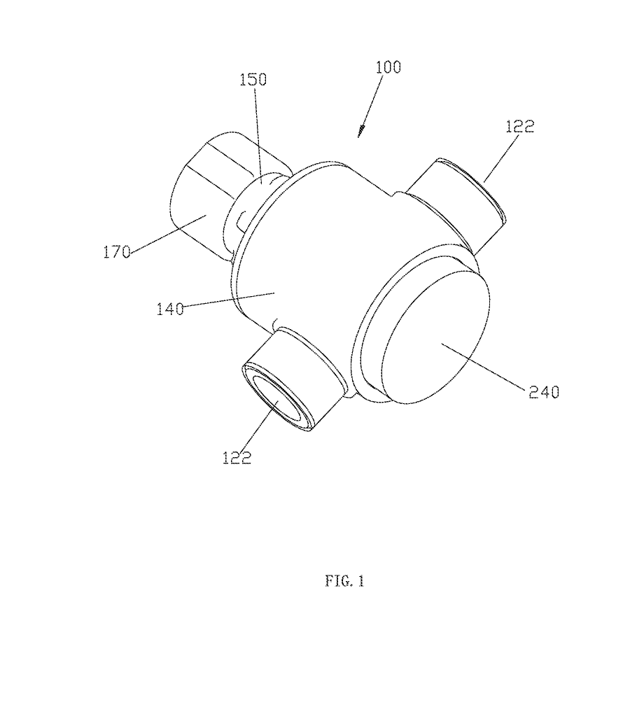

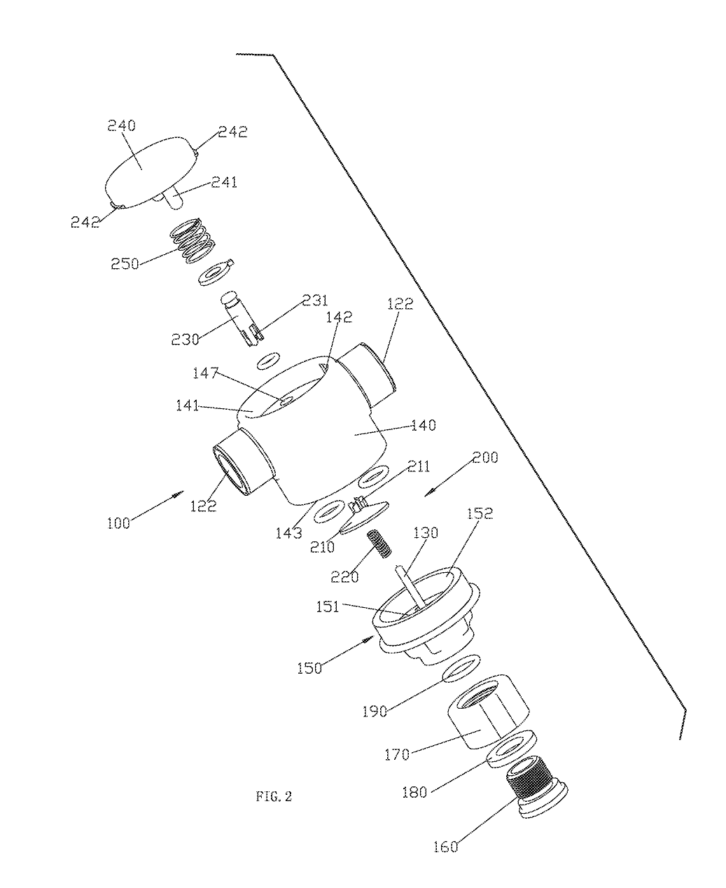

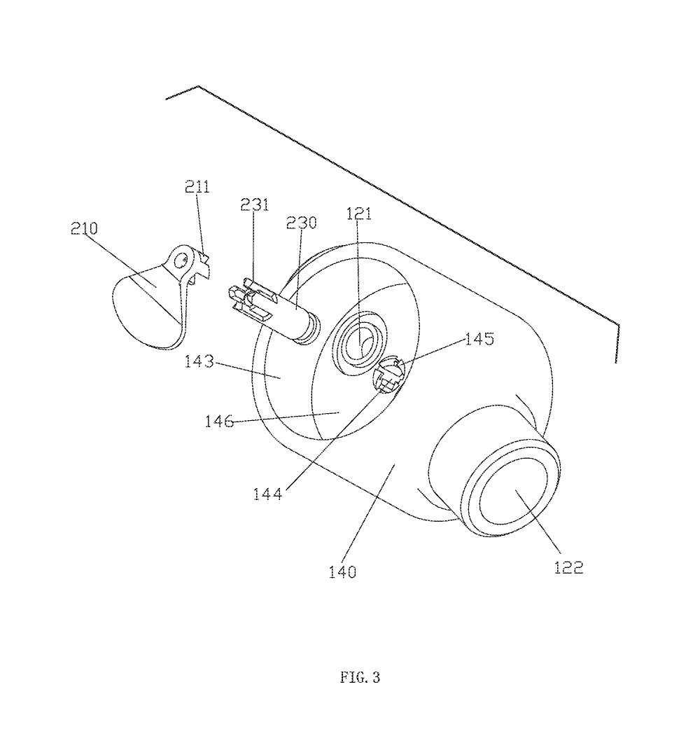

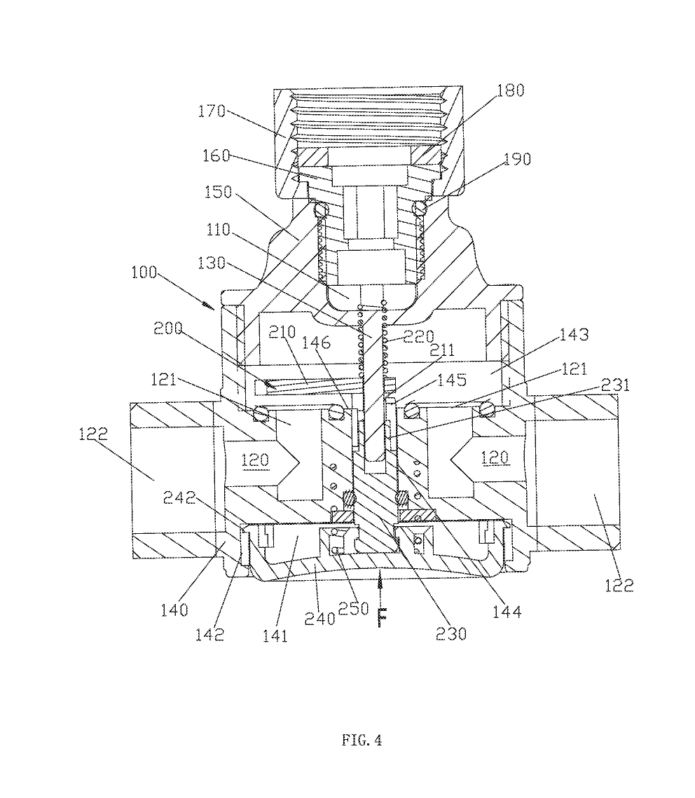

According to FIGS. 1 to 8, the pressing waterway switch mechanism comprises a valve body 100 and a switch mechanism.

The valve body 100 comprises a main body 140, an upper cover 150, a connector 160, a connector nut 170, a gasket 180 and a seal ring 190.

An outlet cavity 143 is concavely arranged on the top surface of the main body 140, of which the bottom surface is the switch surface 146. The upper cover 150 comprises a top wall 151 and a surrounding wall 152 extended from the periphery of the top wall 151. The surrounding wall 150 and the outlet cavity 143 are hermetically fixed together, so that the main body 140 and the upper cover are hermetically fixed together. A mounting groove 141 is concavely arranged on the bottom surface of the main body 140, and a axial locating slot 142 is arranged on the internal revolution surface of the mounting groove 141. A guiding slot 144 penetrating the bottom surface of the outlet cavity 143 and the bottom surface of the mounting groove 141 is also arranged at the main body 140, and the guiding direction of the guiding slot 144 is coincided with the axis of guiding shaft 130. A third teeth group 145 is arranged at the main body 140, and the third teeth group 145 is around the guiding slot 144 and at the switch surface 146. A locating slot 147 is concavely arranged at the switch surface 146 of the main body 140 of the valve body 100.

Two outlet waterways 120 are arranged in the main body 140, the inlet ports 121 of the two outlet waterways 120 are ahead upward and on the switch surface 146, and are alternately arranged around the guiding shaft 130 in a ring array manner, the outlet of the two inlet ports 121 are radially ahead outward. An inlet waterway 110 is arranged on the top wall 151 in a penetrating manner to guide water into the outlet cavity 143, so that the inlet ports 121 of the outlet waterways 120 can be communicated with the inlet waterway 110. In the present embodiment, the upper cover 150 is communicated with water source through the connector 160, the connector nut 170, the gasket 180 and the seal ring 190.

The switch mechanism comprises a sector disk 210, a return spring 220, a pressing piece 230, a button 240 and a against spring 250.

The sector disk 210 is located in the outlet cavity 143 of the main body 140, and a first teeth group 211 is arranged at the circle center of the sector disk 210, and the first teeth group 211 is sleeved out of the guiding shaft 130 in a relative sliding and rotating manner, and then the switch of a plurality of outlet waterways 120 can be at least achieved through the relative rotation between the sector disk 210 and the valve body 100. In the present embodiment, the sector disk 210 can seal the inlet ports 121 in a coupling manner, and can couple between the two inlet ports 121, namely water can be switched to come out of the first outlet waterway, the second outlet waterway or the first and second outlet waterways simultaneously.

The return spring 220 is sleeved to the guiding shaft 130 and against between the top wall 151 and the sector disk 210.

The pressing piece is connected to the guiding slot 144 of the valve body 100 in a sliding manner, and a second teeth group 231 is arranged at the first end of the pressing piece 230, and it is better that a seal mechanism is arranged during sliding process.

In the present embodiment, the first teeth group 211 can couple with the second teeth group 231 and the third teeth group 140, to cause that: the pressing piece 230 is pressed to move forward, and then the sector disk 210 slides forward, and the first teeth group 211 and the second teeth group 231 are coupling with each other, and then the sector disk 210 rotates forward, and energy is stored in the return spring 220; then energy is released from the return spring 220, and then the sector disk 210 slides backward, and the first teeth group 211 and the third teeth group 145 are coupling with each other, and then the sector disk 210 rotates forward, and then the pressing piece 230 returns. The teeth groups can employ the following structure, but not limited, such as the raised teeth in ring array, the tooth face of the raised teeth is provided with inclined cambered surface ahead the same direction (clockwise or anticlockwise), for example, the height of the tooth face is different according to different teeth in turns.

A guiding embossment 242 is arranged out of the button 240, and the button 240 is coupling with the mounting groove 141 that is connected to the valve body 100 in a sliding manner, and the embossment 242 is connected to the locating slot 142 in a coupling manner. a locating rod 241 is convexly arranged on the top surface of the button 240, and the locating rod 241 is connected to the locating slot 147 in a coupling manner.

The against spring 250 is arranged in the mounting groove 141 of the valve body, and is against between the bottom surfaced of the mounting groove 141 and the button 240.

The switch process of the waterway mechanism in the present embodiment can be described as follows:

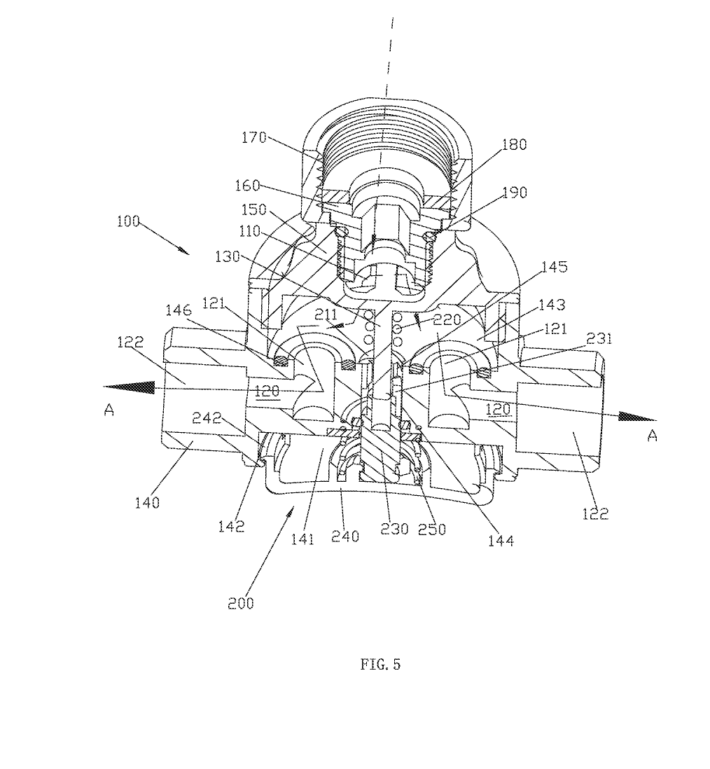

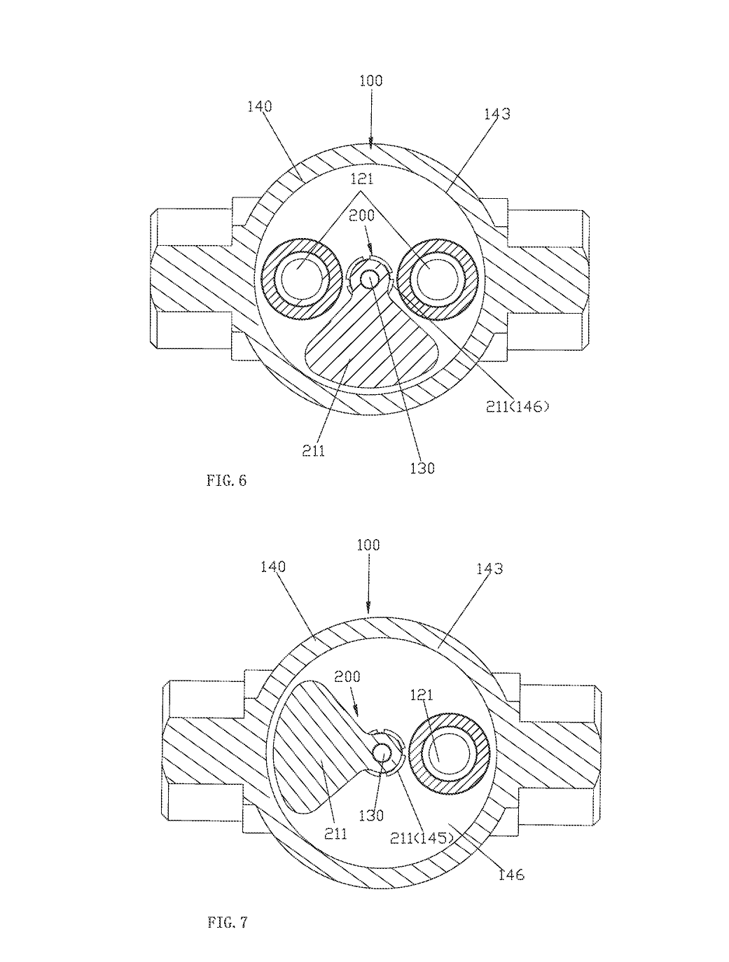

According to FIG. 5 and 6, the sector disk 210 is relying on the switch surface of the valve body 100, and is between the two inlet ports 121, water passes through the inlet waterway 110, the outlet cavity 143, the two inlet ports 121 and the two outlet waterways 120, and then water comes out of the two outlet waterways simultaneously.

The user presses the button 240, and the button 240 is against the second end of the pressing piece 230 to move the pressing piece 230 forward (in the present embodiment, the upward movement is shown in FIG. 5, namely leaves the switch surface), and then the sector disk 210 slides forward (in the present embodiment, as shown in FIG. 6, the forward direction of the sector disk is clockwise), under the cooperation of the first teeth group 211 and the second teeth group 231, the sector disk 210 is rotated forward at 45 degrees, and energy is stored in the return spring 220 and then the against spring 250;

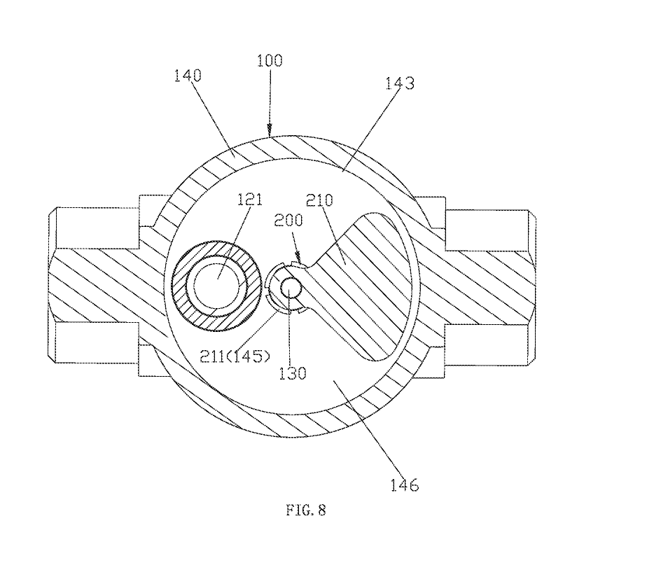

The user looses the button 240, energy is released from the return spring 220, and then the sector disk 210 slides backward, and under the cooperation of the first teeth group 211 and the third teeth group 145, the sector disk 210 is rotated forward at 45 degrees, and the sector disk 210 is covering the inlet ports 121 of the second outlet waterway hermetically at this moment, and then the pressing piece 230 returns, and water source is communicated with the inlet waterway 110 the outlet cavity 143 and a inlet port 121 of the first outlet waterway at this moment, and then water comes out of the first outlet waterway 120 (as shown in FIG. 7). And at the same time, energy is released from the against spring 250, and the button returns.

According to the pattern above, water can be switched to come out of the first outlet waterway, the second outlet waterway or the first and second waterways simultaneously.

The invention has been described with reference to the preferred embodiments mentioned above; therefore it cannot limit the reference implementation of the invention. It is obvious to a person skilled in the art that structural modification and changes can be carried out without leaving the scope of the claims hereinafter and the description above.

### INDUSTRIAL APPLICABILITY

The pressing waterway switch mechanism in the present embodiment, an automatic-ball-pen-type mechanism is composed of the pressing piece, the return spring, the sector disk and the valve body, and the pressing piece is pressed to slide forward, and then the sector disk slides and rotates forward, and then energy is stored in the return spring, when the pressing is loosen, energy is released from the return spring, and then the sector disk slides backward and rotates forward; the structure is simple, and the switch operation is convenient, so that it is provided with good industrial applicability.

What is claimed is:

1. Pressing waterway switch mechanism, wherein, comprises:
A valve body, provided with an inlet waterway, at least two outlet waterways, a guiding shaft, a guiding slot of which the guiding direction coincides with the axis of the guiding shaft, a third teeth group that is around the guiding slot, and inlet ports of the outlet waterways can be communicated with the inlet waterway and be alternatively arranged around the guiding shaft in a ring array manner;
A switch mechanism, comprises:
A sector disk, a first teeth group is arranged at the circle center, and can be sleeved out of the guiding shaft in a relative sliding and rotating manner, and at least the switch of a plurality of outlet waterways can be achieved through the relative rotation between the sector disk and the valve body;
A return spring, is sleeved to the guiding shaft and against the first teeth group;
A pressing piece, can be connected to the guiding slot in a sliding manner, and a second teeth group is arranged at the end of the pressing piece;
Wherein, the first teeth group can couple with the second teeth group and the third teeth group, to cause that: the pressing piece is pressed to move forward, and the first teeth group and the second teeth group are coupling with each other, and then the sector disk slides forward and rotates forward, and energy is stored in the return spring; then energy is released from the return spring, and then the sector disk slides backward, and the first teeth group and the third teeth group are coupling with each other, and then the sector disk rotates forward, and then the pressing piece returns.

2. Pressing waterway switch mechanism according to claim 1, wherein, the sector disk can seal the inlet ports in a coupling manner.

3. Pressing waterway switch mechanism according to claim 2, wherein, the number of the outlet waterways is two, and the sector disk can seal an inlet port alternatively or the sector disk can be between the two inlet ports.

4. Pressing waterway switch mechanism according to claim 1, wherein, the switch mechanism also comprises:
A button, which is connected to the valve body in a sliding manner and be against the pressing piece, so that the pressing piece can be driven to slide when the button is pressed, a locating rod is arranged on the button, and a locating slot is arranged on the valve body, and the locating rod is connected to the locating slot in a coupling manner; and
A against spring, which is arranged between the button and the valve body.

5. Pressing waterway switch mechanism according to claim 4, wherein, the valve body comprises:
A main body, an outlet cavity is concavely arranged on the top surface of the main body, of which the bottom surface is the switch surface, the outlet waterways are arranged in the main body, and the inlet ports are on the switch surface, the guiding slot penetrates the main body, and the third teeth group is on the switch surface;
An upper cover, which is mounted on the circular surface of the outlet cavity of the main body, and the inlet waterway penetrates the upper cover to introduce water into the outlet cavity from water source.

6. Pressing waterway switch mechanism according to claim 5, wherein, the upper cover comprises a top wall and a surrounding wall extended from the periphery of the top wall downward, and the surrounding wall is fixed to the outlet cavity of the main body hermetically, and the inlet waterway penetrates the top wall; the guiding shaft is fixed to the bottom surface of the top wall of the upper cover.

7. Pressing waterway switch mechanism according to claim 6, wherein, the sector disk is in the outlet cavity of the main body, the return spring is against between the top wall and the sector disk.

8. Pressing waterway switch mechanism according to claim 7, wherein, a mounting groove is concavely arranged on the bottom of the main body, and a axial locating slot is arranged on the internal revolution surface of the mounting groove; the button is connected to the mounting groove in a coupling and sliding manner, and a guiding embossment is arranged out of the button, and the embossment is connected to the locating slot in a coupling manner.

9. Pressing waterway switch mechanism according to claim 8, wherein, the against spring is against between the bottom surface of the mounting groove and the button.

10. Pressing waterway switch mechanism according to claim 5, wherein, the outlet ports of the outlet waterways are radially ahead outward.
